(19) United States
(12) Patent Application Publication
(10) Pub. No.: US 2025/0332863 A1
(43) Pub. Date: Oct. 30, 2025

(54) Vehicle Wheel for a Vehicle

(71) Applicant: ACCURIDE WHEELS SOLINGEN GMBH, Solingen (DE)

(72) Inventor: Jörg Schumacher, Wegberg (DE)

(21) Appl. No.: 19/188,382

(22) Filed: Apr. 24, 2025

(30) Foreign Application Priority Data
Apr. 26, 2024 (DE) 10 2024 111 768.0

(51) Int. Cl. B60B 3/00; B60B 3/02

(52) U.S. Cl. CPC B60B 3/007; B60B 3/02

(57) ABSTRACT

A vehicle wheel including a disc segment and a rim segment. The disc segment includes a wheel mounting surface for connecting the vehicle wheel to a vehicle hub and a transition element, wherein the transition element is arranged between the wheel mounting surface and an outer rim flange. The rim segment includes the outer rim flange and an inner rim flange as well as a drop center arranged between the two flanges. The segments of the vehicle wheel are integrally formed in order to shape a one-piece, continuously running vehicle wheel contour profile.

### CROSS-REFERENCE TO RELATED APPLICATION(S)

This application claims the benefit of German Application DE 10 2024 111 768.0 (filed on Apr. 26, 2024), the entirety of which is incorporated by reference herein.

### FIELD OF THE INVENTION

The present invention relates to a vehicle wheel of the type defined in more detail in the preamble of claim 1.

### BACKGROUND

As is known, steel-built vehicle wheels comprise a rim and a wheel disc arranged on the rim. In the case of utility vehicle wheels, for example, the wheel disc is pressed into the rim with a slight oversize and then permanently connected to a circumferential (partially interrupted) weld seam. The wheel disc is either connected in the rim in the section of a connecting area, the so-called ledge (cylindrical connecting area between the rim shoulder and the drop center) or directly in the drop center. To achieve this, the contours of the rim and the wheel disc run alongside one another in an axial direction from the outside of the wheel to the welding seam, which results in a higher material usage and a kind of gap between the two parts. The gap that arises between the wheel disc and the rim contour often impairs the aerodynamics of the vehicle wheel. As part of their aerodynamic optimization efforts, some vehicle manufacturers therefore use wheel covers to improve the aerodynamics of the wheel by covering its entire surface.

There are also designs known for a dish and rim connection in the outer shoulder area. However, these have the significant disadvantage that the fit of the two parts can only be produced with great effort due to the shoulder levels of 5° and 15°, and here too the material overlaps lead to increased material costs and additional weight of the wheel.

The object of the present invention is to at least partially overcome the disadvantages of the state of the art described above. In particular, the object of the present invention is to provide a wheel with improved aerodynamics and reduced material usage. Furthermore, a circumferential connecting welding seam can be omitted completely.

### SUMMARY

The subject of the invention is a vehicle wheel with the features of claim 1. Further features and details of the invention are apparent from the respective sub-claims, the description, and the drawings.

In particular, the subject of the invention is a vehicle wheel comprising a disc segment and a rim segment, wherein the disc segment comprises a wheel mounting surface for connecting the vehicle wheel to a vehicle hub and a transition element, wherein the transition element is arranged between the wheel mounting surface and the outer rim flange, wherein the rim segment comprises an outer and an inner rim flange as well as a drop center arranged between the two flanges. The segments of the vehicle wheel are integrally formed, particularly flow-formed, from a metallic material, in particular from a bandage or a circular blank, in order to shape a one-piece, continuously running vehicle wheel contour profile.

The metallic material may be provided as a bandage of a metallic material. The bandage may be provided with a metallic material such as a steel or aluminum alloy. The shape of the bandage can be designed so that the amount of waste during the production of the vehicle wheel is minimized. The bandage can cover a length and width required to produce the required vehicle wheel. Alternatively, a circular disc can be used instead of the bandage to produce the vehicle wheel according to the invention. The one-piece vehicle wheel allows the disc segment and the rim segment to have neither an overlap nor a connecting welding seam as compared to a wheel disc of a two-piece vehicle wheel welded together with a wheel rim. This has the advantage that the wheel as a one-piece vehicle wheel has no circumferential welding seam or weld seam connections whatsoever. Further, this has the advantage that the contour of the disc segment is directly connected to the rim segment, in particular to the outer rim flange, and produces a closed outer contour of the vehicle wheel, so that the favorable aerodynamic properties of a wheel cover are achieved without using a known wheel cover. Furthermore, the contour of the vehicle wheel from the wheel mounting surface to the outer rim flange enables a material saving in the vehicle wheel, which has a favorable effect on the CO2 footprint of the wheel. Furthermore, the elimination of a circumferential weld between the disc and rim segment has the advantage of saving weight and energy consumption in the production of the vehicle wheel. A wheel cover, if used, can advantageously be reduced to the area of the screw connection system, which again saves costs and weight.

It is possible that the transition element of the disc segment is arranged between the wheel mounting surface of the disc segment and the outer rim flange, in particular a radially outer side of the outer rim flange, of the rim segment.

It is further possible that the segments of the vehicle wheel are integrally shaped or reformed from a bandage or a circular blank, in order to provide a one-piece, continuously running vehicle wheel contour.

It is also possible that the disc segment and the rim segment of the vehicle wheel are integrally formed or shaped from a metallic material, wherein the metallic material is provided as a metallic preform, a bandage or a circular blank.

It is further possible to shape or reform the two segments of the vehicle wheel, which are manufactured as a one-piece by a flow-forming process. In other words, the vehicle wheel and its segments are manufactured by a cold-forming process. This type of process differs from the known molding processes, which use a liquid metallic material to mold a vehicle wheel that has to be heated for molding. Furthermore, the vehicle according to the invention differs from the state of the art in that the one-piece form of the vehicle wheel is not forged, but is formed or manufactured by means of flow forming.

It is further possible that the transition element of the disc segment has a material thickness which is variably formed by a flow-pressing process in order to improve the strength of the vehicle wheel.

It is also possible that the material thickness of the transition element is designed such that an outer contour of the transition element has a wave-shaped contour profile.

It is further possible that wave-shaped is specified as a change of the outer contour profile from convex to concave to convex or vice versa.

This allows the disc segment, in particular the transition element, to be shaped, reformed or flow-formed in a load-and/or weight-optimized manner during the application of the flow-forming process, so that different material thicknesses can be provided in sections. The disc segment can have a significant influence on the distribution of the vehicle's load on the vehicle wheel, which is why it is advantageous to manufacture the material thickness of the disc segment in sections. This can be ensured on the basis of a flow-forming process. Furthermore, this has the advantage that the technical properties of the vehicle, such as handling, acceleration, deceleration and driving safety, can at least be maintained or improved by reducing the material thickness of the disc segment in sections. Furthermore, the contour of the disc segment of the one-piece vehicle wheel can be adapted to compensate for any loss of rigidity due to reduced material thickness.

It is also possible that the material thickness of the transition element gradually decreases radially towards the outer rim flange, in particular to the radially outer side of the outer rim flange.

This allows to achieve the best possible combination of the weight of the vehicle wheel and its strength, depending on the respective material thickness.

It is further possible that the transition element is arranged directly on the outer rim flange, in particular on the radially outer side of the outer rim flange, of the rim segment, and wherein the transition element and the outer rim flange are designed as a circumferential material section of the vehicle wheel that is free of welding seams.

This has the advantage that significantly more resources and weight can be saved by eliminating a welded seam during the manufacturing of the vehicle wheel.

It is further possible that the transition element has an orientation with respect to a central axis of the vehicle wheel, which is directed axially from the outside inwards, axially from the inside outwards or essentially perpendicular to the central axis of the vehicle wheel.

This has the advantage that a vehicle wheel based on this design principle can be flexibly applied to different vehicle wheel types with a suitable wheel offset. The wheel offset is the axial distance between the inner contact surface of the wheel and the center of the rim contour. Furthermore, the required vehicle wheel can be provided with a corresponding alignment of the transition element of the disc segment for different vehicles, such as a passenger car, a commercial vehicle, a truck, or a trailer.

It is also possible that the transition element and/or the wheel mounting surface are each designed to provide a closed contour profile on the outside in order to achieve an aerodynamic effect on the vehicle wheel.

This allows the contour profile of the disc segment of the vehicle wheel to provide advantageous aerodynamic properties, such as those of a corresponding separate wheel cover. Furthermore, the contour profile of the vehicle wheel between the wheel mounting surface and the outer rim flange allows to achieve a material saving in the vehicle wheel, which has an advantageous effect on the CO² footprint of the product.

It is further possible that the vehicle wheel has a valve which is arranged on the outer drop center shoulder or on the rim drop center of the rim segment and can be operated through a recess in the transition element.

This makes it possible to ensure easy and simple operation of the vehicle wheel with regard to filling a vehicle wheel with pneumatic tires.

It is also possible that the rim segment is designed as a 5° or 15° drop center rim.

This makes it possible to ensure compatibility with the various tire constructions of different vehicle types.

It is further possible that the vehicle wheel has a metallic material, wherein the metallic material has a steel alloy or an aluminum alloy.

This has the advantage that, when using a corresponding steel or aluminum alloy, preferably a high-strength quality, good formability of the material can be achieved. Furthermore, this allows that, depending on the type of metallic material, a resistance to damage or formability is improved. When using aluminum alloys, significant weight savings can also be achieved compared to wheels made of steel.

It is further possible that at least one balancing element is arranged on an inner side of the transition element of the disc segment.

Due to the direct connection of the transition element to the rim flange, it is not possible to mount a balancing weight on the outside of the wheel. The use of adhesive balancing weights on the inside of the wheel is aerodynamically advantageous here.

It is also possible that the rim segment has at least one hump, which is arranged between the outer rim shoulder and the ledge or drop center. A hump can be particularly understood as a raised rib or bulge along the circumference of the rim segment, in particular the inner side of the rim. The hump serves to fix the tire on the rim or on the rim segment and to prevent slipping or sliding of the tire, especially at low tire pressure or extreme driving conditions. The use of a second hump on the rear or inner rim shoulder of the rim segment can optionally be provided.

### BRIEF DESCRIPTION OF THE DRAWINGS

Further advantages, features and details of the invention will become apparent from the following description, in which, with reference to the drawings, embodiments of the invention will be described in detail. The features mentioned in the claims and in the description may each individually or in any combination be essential to the invention. The following show:

FIG. 1 a schematic sketch of a wheel profile according to embodiments of the invention,

FIG. 2 a perspective view of a vehicle wheel according to embodiments of the invention,

FIG. 3 a further perspective view of a vehicle wheel according to embodiments of the I invention, and

FIG. 4 a sectional view of a vehicle wheel according to embodiments of the invention.

In the following figures, the identical reference signs are used for the same technical features, even for different embodiments.

### DETAILED DESCRIPTION

The core of the invention is, in particular, a one-piece vehicle wheel for a vehicle, which has a continuous contour profile from the wheel mounting surface, via a transition element or a connecting zone between the mounting surface and the outer rim flange. The vehicle may be a passenger car or a commercial vehicle or a trailer.

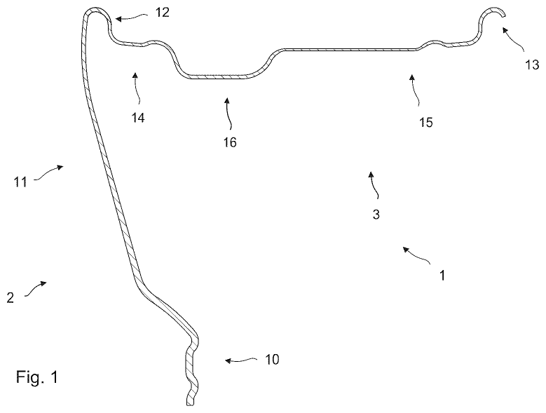

FIG. 1 shows a schematic sketch of a profile of a vehicle wheel according to embodiments of the invention. In particular, FIG. 1 shows a schematic cross-section of a vehicle wheel 1 according to the invention, for example for a passenger car, for a commercial vehicle such as a city delivery van or panel van, or for a trailer. The vehicle wheel 1 comprises a disc segment 2 and a rim segment 3.

The disc segment 2 comprises a wheel mounting surface 10 for connecting the wheel 1 to a vehicle hub (hub not shown) and a transition element 11, wherein the transition element is arranged between the wheel mounting surface 10 and the outer rim flange 12. The transition element 11 of the disc segment 2 is arranged directly on the outer rim flange 12 of the rim segment 3, in particular a radially outer side of the outer rim flange 12 of the rim segment 3, or is integrally connected to it. The transition element 11 according to FIG. 1 is shown with an orientation relative to a central axis of the vehicle wheel 1 that is directed axially from the outside inwards. The wheel profile shown in FIG. 1 may be suitable for a passenger car, for example. Alternatively, other orientations for the transition element 11 with respect to the central axis of the vehicle wheel can be provided, such as axially from the inside to the outside or essentially perpendicular to the central axis of the vehicle wheel 1. The transition element 11 and the outer rim flange 12 are designed as a circumferential material section of the vehicle wheel that is free of welding seams.

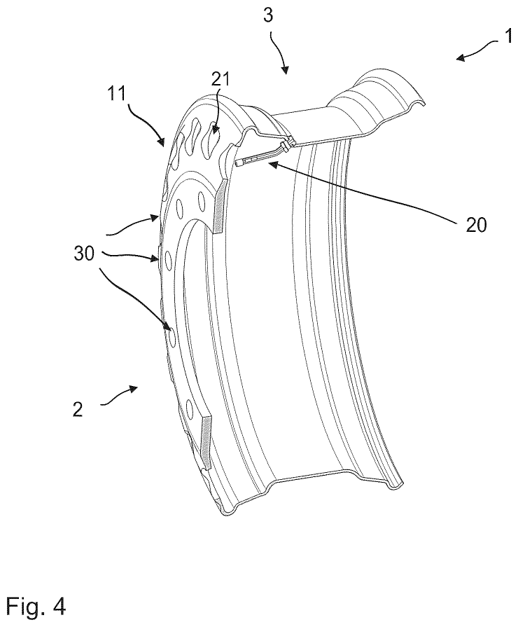

The rim segment 3 may, for example, be provided as a drop-center rim 3, which may, for example, be designed as a 5° or 15° drop-center rim. Furthermore, the rim segment 3 may be symmetrical or asymmetrical. The profile of the rim segment 3 may comprise different sections. According to the embodiment in FIG. 1, the rim segment 3 comprises an outer and an inner rim flange 12, 13 as well as an outer rim shoulder 14 and an inner rim shoulder 15. The outer wheel rim flange 12 can comprise a radially outer side, which can also be referred to as the outward wheel rim flange edge, i.e., the wheel rim flange edge directed away from the vehicle. A drop center 16 is formed between the two rim shoulders 14, 15, which may comprise a drop center bottom. Optionally, it is possible that so-called humps can be arranged between the rim shoulders 14, 15 and the drop center 16. Furthermore, the transition element 11 can have a recess 21 for the valve passage for a valve 20 or comprise ventilation holes 21, as shown in FIG. 4.

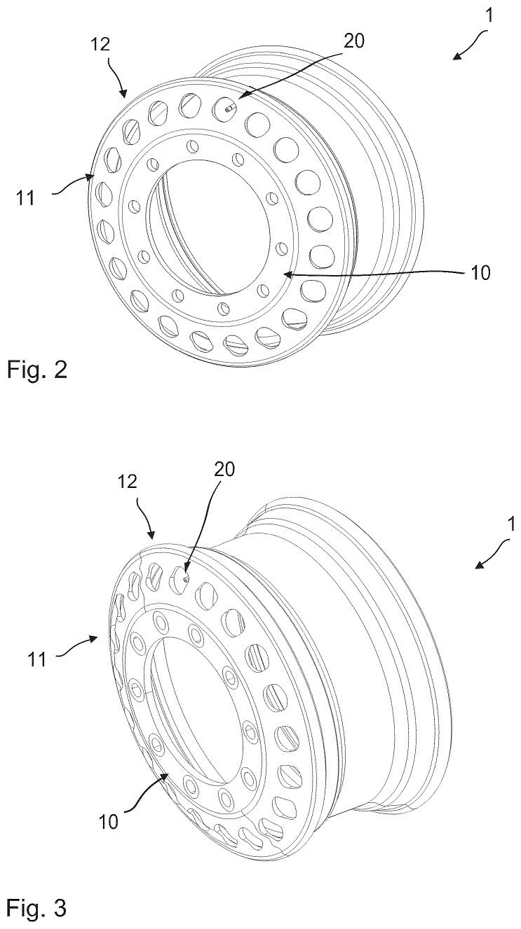

FIG. 2 and FIG. 3 each show a respective perspective view of a vehicle wheel 1 according to embodiments of the invention. In particular, an embodiment for a utility vehicle wheel is shown in each of FIG. 2 and FIG. 3. The transition element 11 depicted in each case in FIG. 2 or FIG. 3 shows, in contrast to FIG. 1, a transition element 11 which, in relation to a central axis of the vehicle wheel 1, has an alignment that is directed axially from the inside outwards (as seen in the direction of the central axis). Such a vehicle wheel 1 can be used, for example, for a utility vehicle.

FIG. 2 shows the one-piece vehicle wheel 1 at an angle from the front, comprising the disc segment 2 and the rim segment 3. In particular, the wheel mounting surface 10 and the transition element 11 are shown in FIG. 2. The wheel mounting surface 10 is used to connect the vehicle wheel 1 to a vehicle hub. For this purpose, several mounting holes 30 can be provided in the wheel mounting surface 10. Furthermore, FIG. 2 shows an exemplary positioning of a valve 20 on the vehicle wheel 1. For the valve 20 arranged in this way, a recess is provided in the transition element 11. This recess 21 (or cutout 21) can be provided as one of the ventilation holes 21. For further aerodynamic optimization, it may be advantageous to reduce the ventilation holes in number and size, or optionally to aerodynamically optimize their shape in the direction of rotation.

In FIG. 3, the one-piece vehicle wheel 1 is shown diagonally overhead projected and shows in particular the rim segment 3 with the associated rim profile between the outer 12 and inner rim flange 13. Furthermore, in FIG. 3, as in FIG. 2, an exemplary profile or pattern of a variable material thickness of the transition element 11 is shown, in particular as a wave-shaped contour profile of the outer contour of the transition element. Optionally, it can be provided that the undulating profile can be specified as a change of the outer contour from convex (outwardly curved) to concave (inwardly curved, i.e., towards the vehicle) to convex or vice versa.

FIG. 4 shows the one-piece vehicle wheel 1 in a sectional view. For example, the valve 20 is shown in FIG. 4, which can be arranged in the area of the outer rim shoulder 14 or in the drop center 16. In order to be able to operate the valve or, for example, to be able to fill with air, a recess 21 is provided in the area of the transition element 11, as already described for FIG. 2. Furthermore, in FIG. 4, the disc segment 2 is shown with a variable material thickness. That is, the material thickness of the transition element 11 according to the embodiment in FIG. 4 is shown to be differently shaped in sections. This can be produced, for example, by means of a flow-forming process.

The above description of the embodiments describes the present invention exclusively in the context of examples. Of course, individual features of the embodiments can be freely combined with one another, provided that this makes technical sense, without leaving the scope of the present invention.

1. A vehicle wheel, comprising: a disc segment; and a rim segment,
wherein the disc segment comprises a wheel mounting surface for connecting the vehicle wheel to a vehicle hub and a transition element, wherein the transition element is arranged between the wheel mounting surface and the outer rim flange, wherein the rim segment comprises an outer rim flange and an inner rim flange as well as a drop center arranged between the two flanges,
wherein the segments of the vehicle wheel are integrally formed from a metallic material in order to shape a one-piece, continuously running vehicle wheel contour profile.

2. The vehicle wheel according to claim 1, wherein the transition element of the disc segment has a material thickness which is variably formed by a flow-pressing method in order to improve the strength of the vehicle wheel.

3. The vehicle wheel according to claim 2, wherein the material thickness of the transition element is designed such that an outer contour of the transition element has a wave-shaped contour profile.

4. The vehicle wheel according to claim 3, wherein wave-shaped is specified as a change in the outer contour profile from convex to concave to convex or vice versa.

5. The vehicle wheel according to claim 2, wherein the material thickness of the transition element gradually decreases radially towards the outer rim flange.

6. The vehicle wheel according to claim 1, wherein the transition element is arranged directly on the outer rim flange of the rim segment, and wherein the transition element and the outer rim flange are designed as a material section of the vehicle wheel which is radially free of welding seams.

7. The vehicle wheel according to claim 1,
wherein the transition element in relation to a central axis of the vehicle wheel, has an orientation which is directed axially from the outside inwards,
axially from the inside outwards or essentially perpendicularly to the central axis of the vehicle wheel.

8. The vehicle wheel according to claim 1, wherein the transition element and/or the wheel mounting surface is/are each designed such that a closed contour profile is provided on the outside in order to achieve an aerodynamic effect of the vehicle wheel.

9. The vehicle wheel according to claim 1, wherein the vehicle wheel has a valve which is arranged on the outer drop-center shoulder or on the rim drop center of the rim segment and can be operated through a recess of the transition element.

10. The vehicle wheel according to claim 1, wherein the rim segment is designed as a 5° or 15° drop-center rim.

11. The vehicle wheel according to claim 2, wherein the material thickness of the transition element gradually decreases radially towards a radially outer side of the outer rim flange.

12. The vehicle wheel according to claim 1, wherein the transition element is arranged directly on a radially outer side of the outer rim flange of the rim segment.
